(19) United States
(12) Patent Application Publication
(10) Pub. No.: US 2005/0036018 A1
(43) Pub. Date: Feb. 17, 2005

(54) Ink set for inket printing

(76) Inventors: Hirokazu Yanagihara, Nagano-ken (JP); Makoto Taniguchi, Nagano-ken (JP)

Correspondence Address: LADAS & PARRY, 26 WEST 61ST STREET, NEW YORK, NY, 10023, US

(21) Appl. No.: 10/478,334

(22) PCT Filed: May 22, 2002
(86) PCT No.: PCT/JP02/04973

(30) Foreign Application Priority Data
May 23, 2001 (JP) 2001-154254
May 23, 2001 (JP) 2001-154255

(51) Int. Cl. G01D 11/00

(52) U.S. Cl. 347/100

(57) ABSTRACT

An inkjet printing ink set giving good discharge stability is provided, which is able to deliver prints with a wide color reproduction gamut, especially pertaining to the yellow-red-magenta hue range, and with extremely low white ground tainting. The inkjet printing ink set of the present invention is for use in inkjet printing onto fabric made up of polyamide fibers, and is equipped with dye inks for at least the two colors yellow and magenta. Its special feature is that the dye ink for yellow contains 5 to 8% by weight of C.I. Acid Yellow 110 as its colorant and the dye ink for magenta contains 2.5 to 5% by weight of C.I. Acid Red 289 as its colorant.

### FIELD OF THE INVENTION

The present invention relates to an ink set for inkjet printing onto a fabric made up of polyamide fibers such as silk, wool or nylon. In particular it relates to an inkjet printing ink set able to provide good discharge stability, excellent color reproduction performance in the yellow-red-magenta hue range, and prints with extremely low white ground tainting; or to an inkjet printing ink set able to provide good discharge stability and prints with extremely low color bleed and white ground tainting.

### BACKGROUND ART

The techniques generally used for printing text and/or images onto woven, non-woven or other types of fabric made from various kinds of fibers are the screen printing method, the roller printing method and certain others. However such printing methods entail the bothersome work of preparing a trace or plate for each design, because of which they are not suited to realize low-cost processes, and are unsuited to the production of numerous different items in small volumes. To eliminate such drawbacks of these traditional printing methods, a method (ink jet printing) has been advanced and developed for practical use, whereby designs are read into a scanner or other image input device, undergo image processing by a computer, and are printed onto the fabric according to the image data by means of the ink jet reproduction technique. This ink jet reproduction technique performs printing by projecting droplets of ink in a jet and causing them to adhere to the substrate. It is a technique that has come to be widely employed in printing fields where the substrate is paper or similar, due to merits including the fact that it readily provides high-quality full-color images.

Ink jet printing generally employs an ink set equipped with dye inks for the four colors: black, yellow, magenta and cyan, and there is a desire for the development of ink sets that would provide prints with high image quality and color fastness while also achieving excellent discharge stability. To date, various inkjet printing ink sets have been put forward in response to this desire, but have had the problem that they are unable to fully reproduce the range of hues that is obtainable with traditional printing methods such as the screen process. Examples of ink sets intended to resolve this problem are seen in Japan Laid-Open Patent Applications H6-25576, H6-57654 and H7-3666, which put forward ink sets composed of multiple dye inks yielding particular ranges for each of chromaticness indexes a* and b* defined in an L*a*b* color space (CIE 1976) on the fabric. However, the ink sets described in these laid-open patent applications have poor color reproduction in the yellow-red-magenta hue range, and an inkjet printing ink set with a color reproduction gamut of adequate range has yet to be provided.

A further example of a response to the aforementioned desire is the ink set put forward in Japan Laid-Open Patent Application H8-259832, where each of the inks for the colors of yellow, magenta and cyan contains a particular acidic dye. However, prints produced using ink jets of this kind suffer from a phenomenon that is known as “color bleed,” the intermixing of different colors at their boundaries, and thus have not been satisfactory in regard to image quality.

Moreover, fabrics printed by inkjet printing are generally subjected to a process (“soaping process”) whereby unfixed dye is washed off with a hot soap solution or similar, during which the washed-off dye is liable to adhere to and taint the white portions of the printed fabric, resulting in “white ground tainting.”

Accordingly, an object of the present invention is to provide an inkjet printing ink set that is able to deliver a broad color reproduction gamut—particularly for the yellow-red-magenta hue range—and prints with extremely low white ground tainting, together with good discharge stability.

Another object of the present invention is to provide an inkjet printing ink set that is able to deliver prints with extremely low color bleed and white ground tainting, together with good discharge stability.

### DISCLOSURE OF THE INVENTION

Through varied examination of the process of obtaining of prints via inkjet printing utilizing an ink set equipped with dye inks for the four colors of black, yellow, magenta and cyan, onto fabric made up of polyamide fibers, the inventors discovered that using a particular acidic dye as colorant for each of the dye inks for yellow and magenta, and controlling the amount of such in the inks to within certain limits, widened the scope of color reproduction for the yellow-red-magenta hue range and, in addition, made it possible to suppress white ground tainting and heighten discharge stability.

One aspect of the present invention is based on the aforementioned discovery and achieves the aforementioned objects by providing an ink set equipped with dye inks for at least the two colors of yellow and magenta for use in inkjet printing onto fabric made up of polyamide fibers, wherein the dye ink for yellow contains 4 to 8% by weight of C.I. Acid Yellow 110 as colorant and the dye ink for magenta contains 2 to 5% by weight of C.I. Acid Red 289 as colorant.

Through varied examination of the process of obtaining of prints via inkjet printing utilizing an ink set equipped with dye inks for the four colors of black, yellow, magenta and cyan, onto fabric made up of polyamide fibers, the inventors further discovered that using a particular acidic dye or direct dye as colorant for each of the four dye inks, controlling the amount of such in the inks to within certain limits, and adding to each of the four dye inks a particular amount of acetylene glycol compound, made it possible to suppress color bleed and white ground tainting and to heighten discharge stability.

Another aspect of the present invention is based on the aforementioned discovery and achieves the aforementioned objects by providing an ink set equipped with dye inks for the four colors of black, yellow, magenta and cyan for use in inkjet printing onto fabric made up of polyamide fibers, wherein the dye ink for black contains 3 to 8% by weight of C.I. Acid Black 52 as colorant, the dye ink for yellow contains 4 to 8% by weight of C.I. Acid Yellow 110 as colorant, the dye ink for magenta contains 2 to 5% by weight of C.I. Acid Red 289 as colorant, the dye ink for cyan contains 3 to 8% by weight of C.I. Direct Blue 87 as colorant, and furthermore each dye ink contains 0.2 to 2% by weight of acetylene glycol compound.

### PREFERRED EMBODIMENTS OF THE INVENTION

The ink set for inkjet printing that constitutes the present invention (also referred to simply as the “inkset” below) is further elaborated below on the basis of preferred embodiments.

The ink set of the preferred embodiments is for use in inkjet printing onto a fabric made up of polyamide fibers and is equipped with dye inks for the four colors of black, yellow, magenta and cyan. The dye inks for black and for cyan are publicly known items, while the dye inks for yellow and for magenta have special features.

Specifically, the dye ink for yellow contains 4 to 8% by weight of C.I. Acid Yellow 110 as its colorant, and the dye ink for magenta contains 2 to 5% by weight of C.I. Acid Red 289 as its colorant.

If the amount of these colorants contained in these dye inks is under the lower limit of the stated range, the print density will be too low, while if the amount is above the upper limit of the stated range, white ground tainting will be liable to occur.

The colorant for the dye ink for black will be one such as is commonly used for black ink of this kind, for instance C.I. Acid Black 52, 107, 155 or 194, with C.I. Acid Black 52 and/or 194 being preferred. The amount of such colorant in the dye ink for black will preferably be 3 to 8% by weight.

The colorant for the dye ink for cyan will be one such as is commonly used for cyan ink of this kind, for instance C.I. Acid Blue 7, 9, 142, 185 or 224, or C.I. Direct Blue 86, 87, 189 or 199, with C.I. Acid Blue 224 and/or C.I. Direct Blue 87 being preferred. The amount of such colorant in the dye ink for cyan will preferably be 3 to 8% by weight.

Since, as stated above, the ink set in the preferred embodiment is equipped with distinct particular dye inks for yellow and for magenta, it has a wider scope of color reproduction for the yellow-red-magenta hue-range compared to conventional inkjet printing ink sets. But to further widen its color reproduction gamut, preferably it will additionally be equipped with dye inks for orange and/or for red.

The colorant for the dye ink for orange will be one such as for instance C.I. Acid Orange 56, 33, 67, or 94, with C.I. Acid Orange 56 being preferred. The amount of such colorant in the dye ink for orange will preferably be 3 to 5% by weight.

The colorant for the dye ink for red will be one such as for instance C.I. Acid Red 249, 138, 315, or 111, with C.I. Acid Red 249 being preferred. The amount of such colorant in the dye ink for orange will preferably be 5.5 to 8% by weight.

From the viewpoint of enhancing the stability of the discharge from the nozzle of the inkjet printer's printing head, it will be preferable for the dye inks in the embodiment to contain humectant. For such humectant one could use any one, or a combination of two or more, of the following or substances similar to them: a polyol or an ether, ester or similar derivative of a polyol, as for example, glycerin, ethylene glycol, diethylene glycol, triethylene glycol, tetraethylene glycol, polyethylene glycol, propylene glycol, dipropylene glycol, polypropylene glycol, 1,3-propanediol, 1,4-butanediol, 1,2-hexanediol, 1,5-pentanediol, 1,6-hexanediol, 1,2,6-hexanetriol, or pentaerythritol; a lactam such as 2-pyrrolidone, N-methyl-2-pyrrolidone or ε-caprolactam; a urea such as urea, thiourea, ethylene urea or 1,3-dimethyl imidazolidinone; or a sugar such as multitol, sorbitol, gluconolacton or maltose.

The amount of such humectant in the dye inks will preferably be 4 to 40% by weight.

Further, from the viewpoint of enhancing the wettability of the fabric and the penetrativity of the dye inks in the embodiment, it will be preferable for the dye inks to contain a water-soluble organic solvent as penetrant. For such water-soluble organic solvent, one could use any one, or a combination of two or more, of the following or substances similar to them: a lower alcohol such as ethanol or propanol; a cellosolve such as ethylene glycol monomethyl ether or ethylene glycol monoethyl ether; a carbitol such as diethylene glycol monomethyl ether or diethylene glycol monoethyl ether; or a glycol ether such as ethylene glycol mono-n-butyl ether, diethylene glycol n-butyl ether or triethylene glycol n-butyl ether.

The amount of such water-soluble organic solvent in the dye inks will preferably be 0.5 to 15% by weight.

From the same viewpoint, it will be preferable for the dye inks in the embodiment to contain a surfactant as penetrant. For such surfactant one could use any one, or a combination of two or more, of the following or substances similar to them: a fatty acid salt; an anionic surfactant such as alkyl sulfate ester salt; a nonionic surfactant such as polyoxyethylene alkyl ester or polyoxyethylene alkyl phenol ester; an acetylene glycol surfactant such as Surfynol 61, 82, 104, 440, 465 or 485 (all of which are trade names of products by Air Products and Chemicals, Inc.); a cationic surfactant or an amphoteric surfactant.

The amount of such surfactant in the dye inks will preferably be 0.1 to 5% by weight.

Further, acetylene glycol compound will preferably be added to such surfactant (penetrant) in an amount of 0.2 to 2% by weight, or more preferably 0.3 to 1.5% by weight. Acetylene glycol compound is employed as a penetrant, and will serve to heighten the wettability of the ink and heighten discharge stability, as well as to heighten penetration into the pre-treated fabric, thus suppressing color bleed. If present in a quantity less than 0.2% by weight, it will exert only meager discharge stability improving effect, while if present in a quantity exceeding 2% by weight, its solubility will be poor and additionally it will raise viscosity.

Thus, the dye inks in the embodiment will each contain a particular colorant, and as necessary will also contain humectant and penetrant, with water added for balance. The water used will preferably be pure or super pure water such as ion-exchanged, ultrafiltered, reverse-osmosed or distilled water. And such water will preferably have undergone sterilization treatment via such as ultraviolet irradiation or addition of hydrogen peroxide, since this will prevent occurrence of mold or bacteria over extended time periods.

The inkjet printing ink set of the present invention needs to be equipped with a minimum of two dye inks for the two colors of yellow and magenta as defined above; the number and types of other inks used may be appropriately determined for particular cases and are not limited to those stated in the above embodiment.

Now follows an elaboration of another preferred embodiment of the ink set of the present invention (sometimes referred to as the “secondary embodiment” below).

As described as above, the ink set of the present invention is for use in inkjet printing onto a fabric made up of polyamide fibers and is equipped with dye inks for the four colors of black, yellow, magenta and cyan.

The dye ink for black contains 3 to 8% by weight of C.I. Acid Black 52 as its colorant.

The dye ink for yellow contains 4 to 8% by weight of C.I. Acid Yellow 110 as its colorant.

The dye ink for magenta contains 2 to 5% by weight of C.I. Acid Red 289 as its colorant.

The dye ink for cyan contains 3 to 8% by weight of C.I. Direct Blue 87 as its colorant.

If the amount of these colorants contained in these dye inks is under the lower limit of the stated range, the print density will be too low, while if the amount is above the upper limit of the stated range, white ground tainting will be liable to occur.

Further, acetylene glycol compound is added to each of the dye inks of the present invention in an amount of 0.2 to 2%—preferably 0.3 to 1.5%—by weight. Acetylene glycol compound is employed as a penetrant, and will serve to heighten the wettability of the ink and heighten discharge stability, as well as to heighten penetration into the pre-treated fabric, thus suppressing color bleed. If present in a quantity less than 0.2% by weight, it will exert only meager discharge stability improving effect, while if present in a quantity exceeding 2% by weight, its solubility will be poor and additionally it will raise viscosity.

For this purpose an acetylene glycol compound such as given by General Formula (I) below will preferably be used. A commercially available acetylene glycol compound such as Surfynol 82, 440, 465 or 485 (all of which are trade names of products by Air Products and Chemicals, Inc.) may also be used as well-suited for the purpose. 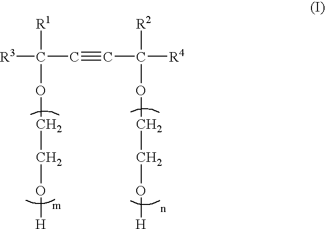
(In this formula 0≦m+n≦50, and R¹ through R⁴ each represent an independent alkyl group)

From the viewpoint of enhancing the discharge stability of the nozzle of the inkjet printer's printing head, the dye inks for the present invention should preferably contain humectant, preferably in the amount 4 to 40% by weight. For such humectant one of the substances previously enumerated may be used.

From the viewpoint of further enhancing the penetrativity of the dye inks of the present invention, it will be preferable for the dye inks to contain a water-soluble organic solvent as penetration promoter. For such water-soluble organic solvent one of the substances previously enumerated may be used.

Thus, the dye inks for this embodiment will each contain particular amounts of a particular colorant and an acetylene glycol compound, and as necessary will also contain humectant and penetration promoter (water-soluble organic solvent), with water added for balance. The water used will preferably be pure or super pure water such as ion-exchanged, ultrafiltered, reverse-osmosed or distilled water. And such water will preferably have undergone sterilization treatment via such as ultraviolet irradiation or addition of hydrogen peroxide, since this will prevent occurrence of mold or bacteria over extended time periods.

The dye inks for embodiments 1 and 2 may also contain as necessary any one, or a combination of two or more, of the following additives commonly used in ink of this kind: antifungal agent/antiseptic agent, antioxidant/ultraviolet absorbent, chelating agent, oxygen absorbent, pH adjuster, solubilizer.

From the viewpoints of balance of printing quality and reliability of the inks for the purposes of inkjet reproduction, the dye inks for embodiments 1 and 2 should preferably have surface tension of 25 to 40 mN/m, and more preferably of 28 to 35 mN/m.

From the same viewpoints, the viscosity at 20 Celsius degree of the dye inks for embodiments 1 and 2 should preferably be 1.5 to 8 mPa·s, and more preferably 2 to 6 mpa·s.

In order to obtain surface tension and viscosity within the stated ranges, it will suffice to employ means to adjust appropriately the concentration of the colorants and the type and amount of the humectant added.

The ink sets in embodiments 1 and 2 are for use in inkjet printing onto fabric made up of polyamide fibers (silk, wool and nylon fibers), and in the same way as ink sets for ordinary inkjet printing, they are fitted into an inkjet printer in order to be used. There is no particular restriction on the inkjet printer with which they are used, although a drop-on-demand type inkjet printer is preferable. Any types of drop-on-demand inkjet printers will be good for the purpose, including those that employ a piezoelectric element recording method using piezoelectric elements deployed at the printing head and those that employ a thermal jet recording method that prints using thermal energy derived from a heat-generating resistive element heater or similar deployed at the printing head.

When the ink sets in embodiments 1 and 2 are used for inkjet printing onto the aforementioned fabrics, it will be preferable to pretreat the fabric in advance using a pretreatment agent, as with ordinary inkjet printing. Pretreatment of the fabric will consist of having the pretreatment agent adhere to the fabric by a method such as dipping the fabric in the agent, or applying or spraying the agent onto the fabric, and then drying the fabric.

For the pretreatment agent, a sizing agent such as a water-soluble polymer will be used in aqueous solution at a concentration of 0.01 to 20% by weight. Such sizing agent might be for example: a starchy substance such as starch of maize or wheat; a cellulosic substance such as carboxymethyl cellulose or hydroxymethyl cellulose; a polysaccharides such as sodium alginate, gum arabic, locust bean gum, trant gum, cyamoposis gum or tamarind seed; a protein such as gelatine or casein; tannin; a natural water-soluble polymer such as lignin; or a synthetic water-soluble polymer such as polyvinyl alcohol compound, polyethylene oxide compound, acrylic acid compound or maleic anhydride.

The pretreatment agent may contain as necessary humectant such as urea or thiourea, and the following additives: pH adjuster, reduction inhibitor, penetrant, sequestrant, antifoamer.

Further, after text or images have been printed onto the aforementioned fabrics in inkjet printing using the ink set of embodiment 1 or 2, the printed fabric will undergo dye-fixing treatment which will consist of a method such as used in conventional printing of this kind, for example the normal-pressure steam method, high-pressure steam method or thermo-fixing method. After the dye-fixing treatment, the fabric will be rinsed with water and dried as per the usual practice. If necessary, it may also be given soaping treatment (in which unfixed dye is washed off with hot soap solution or similar).

Embodiments

Below are embodiment of the present invention and experiments that demonstrate its effects, so as to offer a more concrete description. It should be understood, however, that the scope of the present invention is by no means limited to these embodiments.

Embodiment 1

In this embodiment, prints were produced according to the “Printing method” below, using dye inks prepared according to the “Dye ink preparation formulas” below, and the resulting color reproduction gamut and degree of white ground tainting were evaluated.

Dye Ink Preparation Formulas

Dye inks of the respective compositions given in “Table 1” below for the four colors of yellow, magenta orange and red were prepared.

TABLE 1
(Unit: % by weight)

| | | Magenta | Orange | |
|---|---|---|---|---|
| | Yellow ink | ink | ink | Red ink |
| C.I. Acid Yellow 110 | 7 | — | — | — |
| C.I. Acid Red 289 | — | 3 | — | — |
| C.I. Acid Orange 56 | — | — | 4 | — |
| C.I. Acid Red 249 | — | — | — | 7 |
| Glycerin | 10 | 18 | 12 | 12 |
| Diethylene glycol | 8 | 8 | 8 | 8 |
| Triethylene glycol | 8 | 8 | 8 | 8 |
| monobutyl ether | | | | |
| Surfynol 465 | 1 | 1 | 1 | 1 |
| Triethanolamine | 0.5 | 0.5 | 0.5 | 0.5 |
| Pure water | Remaining | Remaining | Remaining | Remaining |
| | amount | amount | amount | amount |

Printing Method

Solid block patterns of the four aforementioned inks were printed using an inkjet printer (trade name “PM-900C”, by Seiko Epson Corporation) onto three different fabrics, namely wool fabric, nylon fabric and silk fabric, that had been pretreated according to the “Fabric pretreatment” procedure below, thus yielding three different printed fabrics (“Examples 1.1 through 1.3”) . No clogging of the nozzle or other trouble occurred, and stable printing operation was obtained.

Fabric Pretreatment

Pretreatment agents of the compositions given in “Table 2” below were applied respectively to the wool fabric, nylon fabric and silk fabric. The agent was applied to the fabrics with the pickup rate of 90%. Then the fabrics were dried at 120 Celsius degree for two minutes.

TABLE 2
(Unit: % by weight)

| | Example 1-1 | Example 1-2 | Example 1-3 |
|---|---|---|---|
| | For wool | For nylon | For silk |
| Constituent | fabric | fabric | fabric |
| Locust bean gum | 2 | — | — |
| Starch | — | 6 | 2 |
| Urea | 5 | 5 | 5 |
| Ammonium tartrate | 0.5 | 0.5 | 0.5 |
| Sodium chlorate | 0.5 | 0.5 | 0.5 |
| Polyoxyethylene octyl | 1 | — | — |
| phenyl ether | | | |
| Polyoxyethylene nonyl | 1 | 1 | 1 |
| phenyl ether | | | |
| Water | Remaining | Remaining | Remaining |
| | amount | amount | amount |

Steaming treatment (dye-fixing treatment) at temperature of 102 Celsius degree (100 Celsius degree for the nylon fabric) and humidity of 100% was performed for a duration of 30 minutes on the fabrics printed in Examples 1.1 through 1.3. After the steaming treatment, the printed fabrics underwent rinsing, soaping treatment and re-rinsing, following which they were dried with irons to yield the finished prints.

When the prints thus obtained were examined visually to determine their degree of white ground tainting, practically no white ground tainting was found in any print.

### COMPARISON EXAMPLES

Dye inks of the respective compositions given in “Table 3” below for the two colors of yellow and magenta were prepared, and used to produce 3 different prints (Comparison Examples 1.1 through 1.3) according to the same procedure as was followed for Examples 1.1 through 1.3.

TABLE 3
(Unit: % by weight)

| | Yellow ink | Magenta ink |
|---|---|---|
| C.I. Acid Yellow 61 | 7 | — |
| C.I. Acid Red 254 | — | 6 |
| Glycerin | 13 | 11 |
| Diethylene glycol | 8 | 8 |
| Triethylene glycol | 8 | 8 |
| monobutyl ether | | |
| Surfynol 465 | 1 | 1 |
| Triethanolamine | 0.5 | 0.5 |
| Pure water | Remaining | Remaining |
| | amount | amount |

Testing
Evaluation of Color Reproduction Gamut

The colors of the solid block patterns of each print of the Example 1.1 through 1.3 and of the Comparison Example 1.1 through 1.3 were measured using a Model M-2020 Macbeth Spectrophotometer, and used to derive a* and b* values under the CIE color coordinate system. The results are given in “Table 4” below.

TABLE 4

| | | | | | | | Compar- | | Compar- | | Compar- | |
|---|---|---|---|---|---|---|---|---|---|---|---|---|
| | Exam- | | Exam- | | Exam- | | ison | | ison | | ison | |
| | ple | | ple | | ple | | Example | | Example | | Example | |
| Solid | 1.1 | | 1.2 | | 1.3 | | 1.1 | | 1.2 | | 1.3 | |
| Block | Wool | | Nylon | | Silk | | Wool | | Nylon | | Silk | |
| Pat- | fabric | | fabric | | fabric | | fabric | | fabric | | fabric | |
| tern | a* | b* | a* | b* | a* | b* | a* | b* | a* | b* | a* | b* |
| Yellow | −3 | 87 | 0 | 92 | −2 | 93 | −8 | 72 | −7 | 75 | −8 | 75 |
| Magen- | 72 | −4 | 75 | 3 | 77 | −6 | 60 | −10 | 62 | −7 | 63 | −10 |
| ta | | | | | | | | | | | | |
| Orange | 50 | 72 | 55 | 72 | 55 | 76 | — | — | — | — | — | — |
| Red | 73 | 16 | 73 | 20 | 75 | 15 | — | — | — | — | — | — |

As is evident from Table 4, prints of the Example 1.1 through 1.3 had a broader scope of color reproduction for the yellow-red-magenta hue range, and higher image quality, compared to that of the Comparison Example 1.1 through 1.3.

Embodiment 2

In this embodiment, prints were produced according to the “Printing method” below, using dye inks prepared according to the “Dye ink preparation formulas” below, and the resulting degrees of color bleed and white ground tainting were evaluated.

Dye Ink Preparation Formulas

Dye inks of the respective compositions given in “Table 5” below for the four colors of black, yellow, magenta and cyan were prepared.

TABLE 5
(Unit: % by weight)

| | | | Magenta | |
|---|---|---|---|---|
| | Black ink | Yellow ink | ink | Cyan ink |
| C.I. Acid Black 52 | 8 | — | — | — |
| C.I. Acid Yellow 110 | — | 8 | — | — |
| C.I. Acid Red 289 | — | — | 5 | — |
| C.I. Direct Blue 87 | — | — | — | 8 |
| Glycerin | 11 | 11 | 17 | 13 |
| Diethylene glycol | 8 | 8 | 8 | 8 |
| Triethylene glycol | 8 | 8 | 8 | 8 |
| monobutyl ether | | | | |
| Surfynol 465 | 1 | 1 | 1 | 1 |
| Triethanolamine | 0.5 | 0.5 | 0.5 | 0.5 |
| Pure water | Remaining | Remaining | Remaining | Remaining |
| | amount | amount | amount | amount |

Printing Method

Solid block patterns of the four aforementioned inks were printed as close together to each other as possible (to facilitate visual determination of the degree of color bleed) using an inkjet printer (trade name “PM-900C”, by Seiko Epson Corporation) onto three different fabrics, namely wool fabric, nylon fabric and silk fabric, that had been pretreated according to the “Fabric pretreatment” procedure below, thus yielding three different printed fabrics (Examples 2.1 through 2.3). No clogging of the nozzle or other trouble occurred, and stable printing operation was obtained.

Fabric Pretreatment

Pretreatment agents of the compositions given in “Table 6” below were applied respectively to the wool fabric, nylon fabric and silk fabric. The agent was applied to the fabrics with the pickup rate of 90%. Then the fabrics were dried at 120 Celsius degree for two minutes.

TABLE 6
(Unit: % by weight)

| | Example 2-1 | Example 2-2 | Example 2-3 |
|---|---|---|---|
| | For wool | For nylon | For silk |
| Constituent | fabric | fabric | fabric |
| Locust bean gum | 2 | — | — |
| Starch | — | 6 | 2 |
| Urea | 5 | 5 | 5 |
| Ammonium tartrate | 0.5 | 0.5 | 0.5 |
| Sodium chlorate | 0.5 | 0.5 | 0.5 |
| Polyoxyethylene octyl | 1 | — | — |
| phenyl ether | | | |
| Polyoxyethylene nonyl | 1 | 1 | 1 |
| phenyl ether | | | |
| Water | Remaining | Remaining | Remaining |
| | amount | amount | amount |

Steaming treatment (dye-fixing treatment) at temperature of 102 Celsius degree (100 Celsius degree for the nylon fabric) and humidity of 100% was performed for a duration of 30 minutes on the fabrics printed in Examples 2.1 through 2.3. After the steaming treatment, the printed fabrics underwent rinsing, soaping treatment and re-rinsing, following which they were dried with irons to yield the finished prints.

When the prints thus obtained were examined visually to determine their degrees of color bleed and white ground tainting, practically no color bleed or white ground tainting were found in any print.

Industrial Applicability

According to one aspect of the present invention, there is provided an inkjet printing ink set able to deliver prints with a wide color reproduction gamut, especially pertaining to the yellow-red-magenta hue range, and with extremely low white ground tainting. Moreover this inkjet printing ink set is of high reliability, providing good discharge stability and not liable to cause clogging of the printer's nozzle.

According to another aspect of the present invention, there is provided an inkjet printing ink set able to deliver prints with extremely low color bleed and white ground tainting. Moreover this inkjet printing ink set is of high reliability, providing good discharge stability and not liable to cause clogging of the printer's nozzle.

1. An ink set for use in inkjet printing onto fabric made up of polyamide fibers, which is equipped with dye inks for at least the two colors of yellow and magenta,
wherein the dye ink for yellow contains 4 to 8% by weight of C. I. Acid Yellow 110 as its colorant, and
the dye ink for magenta contains 2 to 5% by weight of C. I. Acid Red 289 as its colorant.

2. The inkjet printing ink set as in claim 1, which is additionally equipped with dye inks for orange and/or red.

3. The inkjet printing ink set as in claim 2, wherein the dye ink for orange contains 3 to 5% by weight of C. I. Acid Orange 56 as its colorant and the dye ink for red contains 5.5 to 8% by weight of C. I. Acid Red 249 as its colorant.

4. The inkjet printing ink set as in claim 1, which is additionally equipped with dye inks for black and/or cyan.

5. The inkjet printing ink set as in claim 4, wherein the dye ink for black contains 4 to 8% by weight of C.I. Acid Black 52 as its colorant and the dye ink for cyan contains 4 to 8% by weight of C. I. Direct Blue 87 as its colorant.

6. The inkjet printing ink set as claim 1, wherein each of the dye inks contains humectant, a water-soluble organic solvent (penetrant), a surfactant, and water.

7. The inkjet printing ink set as in claim 6, wherein the humectant is contained in the amount 4 to 40% by weight, the water-soluble organic solvent in the amount 0.5 to 15% by weight, and the surfactant in the amount 0.1 to 5% by weight, in the dye inks.

8. The inkjet printing ink set as in claim 6, wherein the surfactant is an acetylene glycol compound.

9. A printing method whereby the inkjet printing ink set as in claim 1 is used to perform inkjet printing onto fabric.

10. Prints produced using the printing method as in claim 9.

11. The inkjet printing ink set as in claim 2, which is additionally equipped with dye inks for black and/or cyan.

12. The inkjet printing ink set as in claim 3, which is additionally equipped with dye inks for black and/or cyan.

13. The inkjet printing ink set as claim 2, wherein each of the dye inks contains humectant, a water-soluble organic solvent (penetrant), a surfactant, and water.

14. The inkjet printing ink set as claim 3, wherein each of the dye inks contains humectant, a water-soluble organic solvent (penetrant), a surfactant, and water.

15. The inkjet printing ink set as claim 4, wherein each of the dye inks contains humectant, a water-soluble organic solvent (penetrant), a surfactant, and water.

16. The inkjet printing ink set as claim 5, wherein each of the dye inks contains humectant, a water-soluble organic solvent (penetrant), a surfactant, and water.

17. The inkjet printing ink set as in claim 7, wherein the surfactant is an acetylene glycol compound.

18. A printing method whereby the inkjet printing ink set as in claim 2, is used to perform inkjet printing onto fabric.

19. A printing method whereby the inkjet printing ink set as in claim 3, is used to perform inkjet printing onto fabric.

20. A printing method whereby the inkjet printing ink set as in claim 4, is used to perform inkjet printing onto fabric.
